(19) United States
(12) Patent Application Publication
(10) Pub. No.: US 2022/0181910 A1
(43) Pub. Date: Jun. 9, 2022

(54) POWER RECEIVING DEVICE, MOVABLE UNIT, AND WIRELESS POWER TRANSMISSION SYSTEM

(71) Applicant: Panasonic Intellectual Property Management Co., Ltd., Osaka (JP)

(72) Inventors: Hiroyuki HOSOI, Kanagawa (JP); Hiroshi YAMAMOTO, Osaka (JP); Satoru KIKUCHI, Osaka (JP); Toru MATSUGI, Osaka (JP); Masanori AKINAKA, Osaka (JP); Akira NISHIKAWA, Osaka (JP)

(21) Appl. No.: 17/599,238

(22) PCT Filed: Mar. 26, 2020
(86) PCT No.: PCT/JP2020/013808

§ 371 Date: Sep. 28, 2021

(30) Foreign Application Priority Data
Mar. 29, 2019 (JP) 2019-067876

(51) Int. Cl. H02J 50/05; H04B 5/00; B60L 53/10

(52) U.S. Cl. CPC H02J 50/05; B60L 2210/10; B60L 53/10; H04B 5/0037

(57) ABSTRACT

A power receiving device includes: a power receiving antenna to wirelessly receive AC power from a power transmitting antenna in the power transmitting device; a power receiving circuit to convert the AC power received by the power receiving antenna into DC power and to output the DC power; an impedance adjustment circuit disposed on a transmission path between a load that utilizes the DC power and the power receiving antenna, the impedance adjustment circuit being capable of causing a change in input impedance thereof; and a power reception control circuit to control the impedance adjustment circuit. The power reception control circuit consecutively changes a value of the input impedance of the impedance adjustment circuit to a value selected from among a plurality of values, determines from among the plurality of values a value at which power to be supplied to the load becomes largest, and sets and maintains the input impedance at an operating impedance value that is based on the determined value.

### TECHNICAL FIELD

The present disclosure relates to a power receiving device, a movable unit, and a wireless power transmission system.

### BACKGROUND ART

Recent years have seen development of wireless power transmission techniques for wirelessly (contactlessly) transmitting electric power to devices that are capable of moving or being moved, e.g., mobile phones and electric vehicles. Wireless power transmission techniques include the magnetic field coupling method, the electric field coupling method, and other methods. A wireless power transmission system based on the electromagnetic induction method is such that, while a power transmitting coil and a power receiving coil are opposed to each other, electric power is wirelessly transmitted from the power transmitting coil to the power receiving coil. On the other hand, a wireless power transmission system based on the electric field coupling method is such that, while a pair of transmission electrodes and a pair of reception electrodes are opposed to each other, electric power is wirelessly transmitted from the pair of transmission electrodes to the pair of reception electrodes.

Patent Document 1 discloses an example of a wireless power transmission system. The wireless power transmission system includes a power transmitting device and a power receiving device. The power receiving device includes a rectifier, a DC converter, and a control device. The rectifier rectifies AC power which is received by a power receiving resonator from a power transmitting resonator, and converts it into DC power. The DC converter performs DC conversion for the DC power that is output from the rectifier. Based on an input voltage to the DC converter, the control device calculates a command current value such that the input impedance of the DC converter equals a setting value, and controls the DC converter so that the input current to the DC converter equals the command current value. It is stated that, through such control, the efficiency of power transmission is improved and that destruction of component elements can be avoided.

### CITATION LIST

### Patent Literature

[Patent Document 1] Japanese Laid-Open Patent Publication No. 2013-215066

### SUMMARY OF INVENTION

### Technical Problem

The present disclosure provides a technique of suppressing degradation of the efficiency of power transmission associated with changes in the state of wireless power transmission.

### Solution to Problem

A power receiving device according to one implementation of the present disclosure is for use in a wireless power transmission system that includes a power transmitting device and the power receiving device. The power receiving device includes: a power receiving antenna to wirelessly receive AC power from a power transmitting antenna in the power transmitting device; a power receiving circuit to convert the AC power received by the power receiving antenna into DC power and to output the DC power; an impedance adjustment circuit disposed on a transmission path between a load that utilizes the DC power and the power receiving antenna, the impedance adjustment circuit being capable of causing a change in input impedance thereof; and a power reception control circuit to control the impedance adjustment circuit. The control circuit consecutively changes a value of the input impedance of the impedance adjustment circuit to a value selected from among a plurality of values, determines from among the plurality of values a value at which power to be supplied to the load becomes largest, and sets and maintains the input impedance at an operating impedance value that is based on the determined value.

General or specific aspects of the present disclosure may be implemented using a system, an apparatus, a method, an integrated circuit, a computer program, or a storage medium, or any combination of a system, an apparatus, a method, an integrated circuit, a computer program, and/or a storage medium.

### Advantageous Effects of Invention

According to a technique of the present disclosure, degradation of the efficiency of power transmission associated with changes in the state of wireless power transmission can be suppressed.

### BRIEF DESCRIPTION OF DRAWINGS

FIG. 1 A diagram showing schematically showing an example of a wireless power transmission system based on the electric field coupling method.

FIG. 2 A diagram showing a general configuration of the wireless power transmission system shown in FIG. 1.

FIG. 3 A diagram schematically showing another example of a wireless power transmission system based on the electric field coupling method.

FIG. 4 A diagram showing a general configuration of the wireless power transmission system shown in FIG. 3.

FIG. 5 A diagram showing an exemplary configuration of a power transmitting circuit and a power receiving circuit.

FIG. 6A A graph showing an example relationship between the load impedance and the output power.

FIG. 6B A graph showing an example relationship between the output power and the efficiency of power transmission.

FIG. 7 A block diagram showing the configuration of a wireless power transmission system according to an illustrative embodiment of the present disclosure.

FIG. 8 A diagram showing a more specific exemplary configuration of a power transmitting circuit and a power receiving circuit.

FIG. 9A A diagram schematically showing an exemplary configuration of an inverter circuit.

FIG. 9B A diagram schematically showing an exemplary configuration of a rectifier circuit.

FIG. 10 A diagram showing one example of the circuit configuration of a DC-DC converter.

FIG. 11 A diagram schematically showing example waveforms of an output voltage and an output current of an inverter circuit.

FIG. 12 A diagram showing an exemplary configuration of a detector and a power transmission control circuit.

FIG. 13 A diagram showing an exemplary configuration of a charge-discharge control circuit.

FIG. 14 A flowchart showing an example operation of a power transmitting device.

FIG. 15 A flowchart showing an example operation of a power receiving device.

FIG. 16 A flowchart showing another example operation of a power receiving device.

FIG. 17A A diagram showing an example where an impedance adjustment circuit is positioned between reception electrodes and the power receiving circuit.

FIG. 17B A diagram showing an example where an impedance adjustment circuit is positioned between a matching circuit and the rectifier circuit.

FIG. 17C A diagram showing an example where an impedance adjustment circuit is positioned between the rectifier circuit and the charge-discharge control circuit.

FIG. 17D A diagram showing an example where an impedance adjustment circuit is positioned between the charge-discharge control circuit and a battery.

FIG. 18A A diagram showing an example where the transmission electrodes are installed on a lateral surface e.g., a wall.

FIG. 18B A diagram showing an example where the transmission electrodes are installed on a ceiling.

FIG. 19 A diagram showing an example system in which electric power is wirelessly transmitted through coupling between coils.

### DESCRIPTION OF EMBODIMENTS

(findings providing the basis of the present disclosure)

Prior to describing embodiments of the present disclosure, findings providing the basis of the present disclosure will be described.

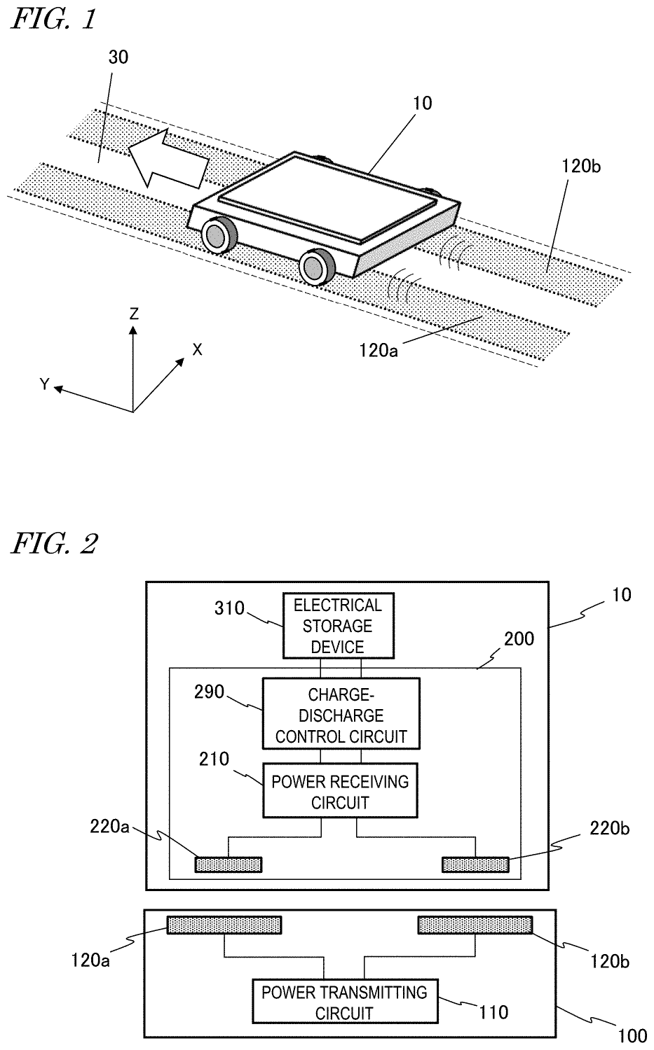

FIG. 1 is a diagram schematically showing an example of a wireless power transmission system. The wireless power transmission system shown in the figure may be a system which wirelessly transmits electric power, through electric field coupling between electrodes, to a movable unit 10 that is used in transporting articles in a factory or a warehouse, for example. The movable unit 10 in this example is an automated guided vehicle (AGV). In this system, a pair of transmission electrodes 120a and 120b, which are in plate shape, are disposed on the floor surface 30. The pair of transmission electrodes 120a and 120b have a shape that is elongated in one direction. To the pair of transmission electrodes 120a and 120b, AC power is supplied from a power transmitting circuit not shown.

The movable unit 10 includes a pair of reception electrodes (not shown) opposing the pair of transmission electrodes 120a and 120b. With the pair of reception electrodes, the movable unit 10 receives AC power which has been transmitted from the transmission electrodes 120a and 120b. The received electric power is supplied to a load in the movable unit 10, e.g., a motor, a secondary battery, or a capacitor for electrical storage purposes. With this, the movable unit 10 may be driven or charged.

FIG. 1 shows XYZ coordinates indicating the X, Y and Z directions which are orthogonal to one another. The following description will rely on XYZ coordinates as shown in the figures. The direction that the transmission electrodes 120a and 120b extend will be referred to as the Y direction; a direction which is perpendicular to the surface of the transmission electrodes 120a and 120b as the Z direction; and a direction which is perpendicular to the Y direction and the Z direction as the X direction. Note that the orientation of any structure that is shown in a drawing of the present application is so set for ease of description, and it shall not limit the orientation in which an embodiment of the present disclosure may actually be employed. Moreover, the particular shape and size with which the whole or a part of any structure may be presented in a drawing shall not limit its actual shape and size.

FIG. 2 is a diagram showing the general configuration of the wireless power transmission system shown in FIG. 1. The wireless power transmission system includes a power transmitting device 100 and a movable unit 10. The power transmitting device 100 includes a pair of transmission electrodes 120a and 120b, and a power transmitting circuit 110 which supplies AC power to the transmission electrodes 120a and 120b. The power transmitting circuit 110 is, for example, an AC output circuit including an inverter circuit. The power transmitting circuit 110 converts DC power which is supplied from a power supply not shown into AC power, and outputs it to the pair of transmission electrodes 120a and 120b. The movable unit 10 includes a power receiving device 200 and an electrical storage device 310. The power receiving device 200 includes a pair of reception electrodes 220a and 220b, a power receiving circuit 210, and a charge-discharge control circuit 290. The electrical storage device 310 is a device that stores electric power, e.g., a motor, a capacitor for electrical storage purposes, or a secondary battery. The power receiving circuit 210 converts the AC power received by the reception electrodes 220a and 220b into a voltage required by the electrical storage device 310, e.g., a DC voltage of a predetermined voltage level, and outputs it. The power receiving circuit 210 may include various circuits, e.g., a rectifier circuit and an impedance matching circuit. The charge-discharge control circuit 290 is a circuit that controls charging and discharging of the electrical storage device 310. Although not shown in FIG. 2, the movable unit also includes other loads, such as electric motors for driving purposes. Through electric field coupling between the pair of transmission electrodes 120a and 120b and the pair of reception electrodes 220a and 220b, electric power is wirelessly transmitted while the two pairs are opposed to each other.

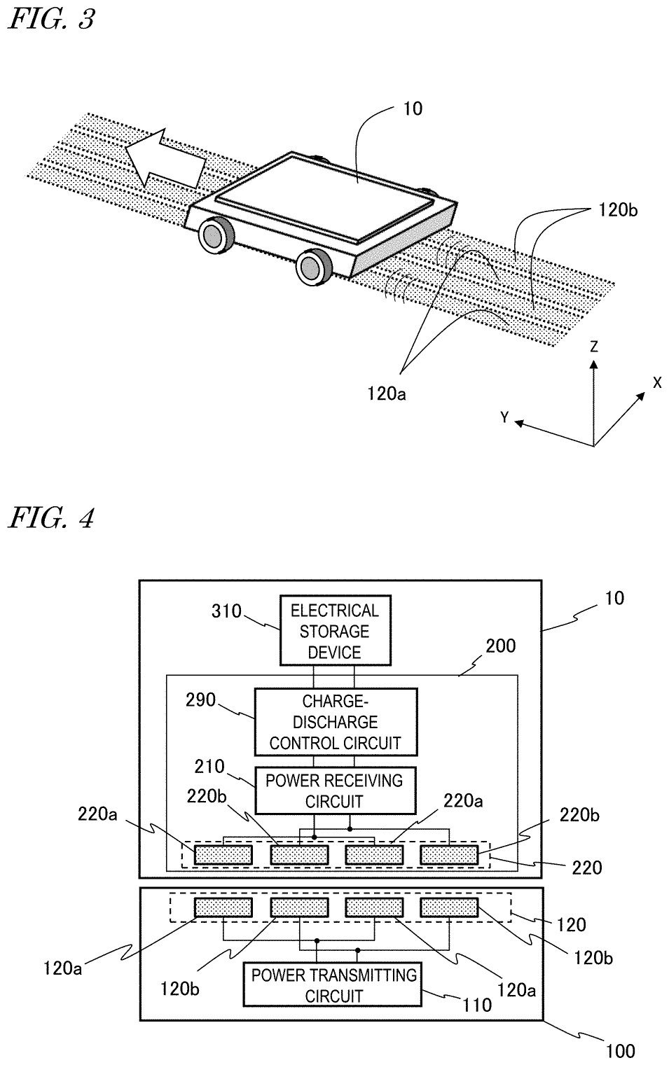

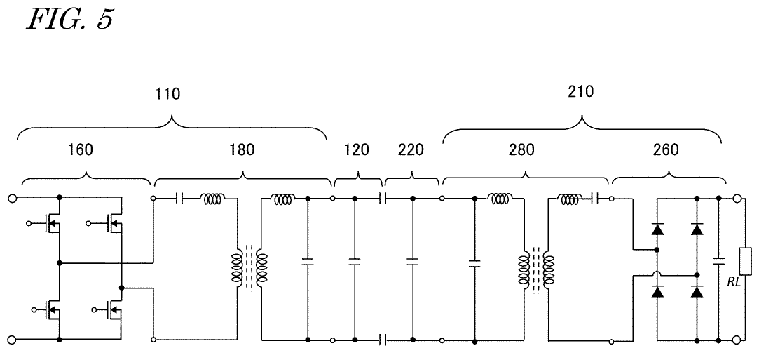

Each of the transmission electrodes 120a and 120b and the reception electrodes 220a and 220b may be split into two or more portions. For example, a configuration as shown in FIG. 3 and FIG. 4 may be adopted.

FIG. 3 and FIG. 4 are diagrams showing an example of a wireless power transmission system in which each of the transmission electrodes 120a and 120b and the reception electrodes 220a and 220b is split into two portions. In this example, the power transmitting device 100 includes two first transmission electrodes 120a and two second transmission electrodes 120b. The first transmission electrodes 120a and the second transmission electrodes 120b are arranged in an alternating manner. Similarly, the power receiving device 200 includes two first reception electrodes 220a and two second reception electrodes 220b. The two first reception electrodes 220a and the two second reception electrodes 220b are arranged in an alternating manner. During power transmission, the two first reception electrodes 220a are opposed to the two first transmission electrodes 120a, and the two second reception electrodes 220b are opposed to the two second transmission electrodes 120b. The power transmitting circuit 110 includes two terminals to output AC power. One terminal is connected to the two first transmission electrodes 120a, whereas the other terminal is connected to the two second transmission electrodes 120b. During power transmission, the power transmitting circuit 110 applies a first voltage to the two first transmission electrodes 120a, and applies a second voltage of an opposite phase to the first voltage to the two second transmission electrodes 120b. As a result of this, through electric field coupling between the transmission electrode group 120 including four transmission electrodes and the reception electrode group 220 including four reception electrodes, electric power is wirelessly transmitted. Such a configuration provides an effect of suppressing a leakage field over a boundary between any two adjacent transmission electrodes. Thus, in each of the power transmitting device 100 and the power receiving device 200, the number of electrodes with which to perform power transmission or power reception is not limited to two.

In the following embodiments, as shown in FIG. 1 and FIG. 2, a configuration in which the power transmitting device 100 includes two transmission electrodes and the power receiving device 200 includes two reception electrodes will be mainly described. In each of the following embodiments, each electrode may be split into multiple portions as illustrated in FIG. 3 and FIG. 4. In either case, an electrode(s) to which a first voltage is applied at a given moment and an electrode(s) to which a second voltage of an opposite phase to the first voltage is applied are arranged in an alternating manner. As used herein, an “opposite phase” is defined to encompass a phase difference which is anywhere in the range from 90 degrees to 270 degrees, without being limited to the case where the phase difference is 180 degrees. In the following description, a plurality of transmission electrodes included in the power transmitting device 100 may be non-discriminately referred to as “transmission electrodes 120” and a plurality of reception electrodes included in the power receiving device 200 may be non-discriminately referred to as “reception electrodes 220”.

With such a wireless power transmission system, the movable unit 10 is able to wirelessly receive electric power while moving along the transmission electrodes 120. While the transmission electrodes 120 and the reception electrodes 220 remain in a closely opposed state, the movable unit 10 is able to move along the transmission electrodes 120. As a result, the movable unit 10 is able to move while charging the electrical storage device 310, e.g., a battery or a capacitor.

In such a wireless power transmission system, when the weight of the load carried on the movable unit 10 is changed, or the course of the movable unit 10 deviates from the direction that the transmission electrodes 120 extend, a capacitance between the electrodes may change from the design value. When the capacitance between the electrodes changes, a mismatch in impedance between circuits may occur, causing problems such as degradation of the transmission efficiency, or heating or damaging of circuit elements. Similar problems may also occur when the load state has changed, or the characteristic values of circuit elements in the power transmitting circuit or the power receiving circuit are deviated from their designed values.

The above problem may occur not only in a wireless power transmission system based on the electric field coupling method, but also in a wireless power transmission system based on the magnetic field coupling method. In other words, because of fluctuations in the coupling state between the coils or fluctuations in the load state, problems such as degradation of the efficiency of power transmission or heating or damaging of circuit elements may occur.

The inventors have studied control methods for solving the above problems. As a result, they have found that the aforementioned problem can be solved by adjusting the impedance in the power receiving device so that a large electric power will be supplied to a load. This point will be described below.

FIG. 5 is a diagram showing the circuit configuration of the power transmitting circuit 110, the transmission electrodes 120, the reception electrodes 220, and the power receiving circuit 210 in an illustrative wireless power transmission system. The power transmitting circuit 110 in this example includes an inverter circuit 160 and a matching circuit 180. The power receiving circuit 210 includes a matching circuit 280 and a rectifier circuit 260. The matching circuit 180 is connected between the inverter circuit 160 and the transmission electrodes 120, and matches the inverter circuit 160 and the transmission electrodes 120 in impedance. The matching circuit 280 is connected between the reception electrodes 220 and the rectifier circuit 260 and matches the reception electrodes 220 and the rectifier circuit 260 in impedance.

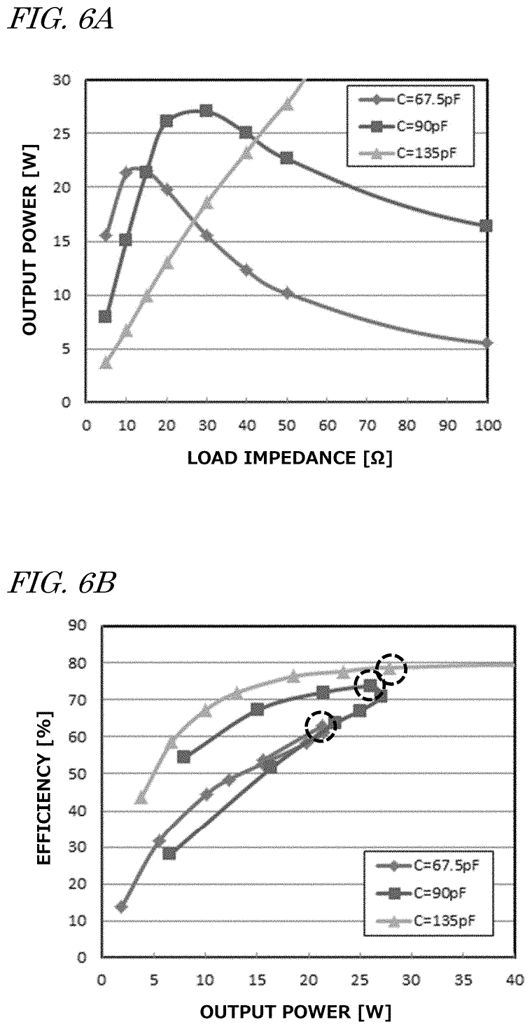

FIG. 6A and FIG. 6B are diagrams showing results of an experiment performed by the inventors with respect to the configuration shown in FIG. 5. In this experiment, with respect to the configuration shown in FIG. 5, the parameters of each circuit element were set to appropriate values, and, while varying the impedance RL of the load, the output power of the rectifier circuit 260 and the efficiency of power transmission were calculated. The experiment was conducted for the case where the capacitance between the transmission electrodes 120 and the reception electrodes 220 was C=90 pF, which was the design value, as well as the case where C=67.5 pF and the case where C=135 pF, which were deviated from the design value.

FIG. 6A shows an example relationship between the load impedance and the output power. FIG. 6B shows an example relationship between the output power and the transmission efficiency. As shown in FIG. 6A, when the capacitance C between the electrodes changes, dependence of the output power on the load impedance also changes. The output power becomes largest at a certain value of load impedance, which is determined depending on the capacitance C between the electrodes. As shown in FIG. 6B, irrespective of the value of the capacitance C between the electrodes, the efficiency of power transmission tends to increase as the output power increases. A broken-lined circle in FIG. 6B represents a point at which a high efficiency is obtained for each value of the capacitance C.

From this result, it was found that, even if the coupling state between the antennas or the load state changes so that the characteristics of wireless power transmission change, it is still possible to maintain a high efficiency of power transmission by controlling the impedance in the power receiving device so that the power to be supplied to the load is kept high. Through such control, the matching state within the circuit can be improved, and heating or break down of circuit elements can be suppressed.

Through the above thoughts, the inventors have arrived at the configurations of embodiments of the present disclosure described below.

A power receiving device according to one implementation of the present disclosure is for use in a wireless power transmission system that includes a power transmitting device and the power receiving device. The power receiving device includes: a power receiving antenna to wirelessly receive AC power from a power transmitting antenna in the power transmitting device; a power receiving circuit to convert the AC power received by the power receiving antenna into DC power and to output the DC power; an impedance adjustment circuit disposed on a transmission path between a load that utilizes the DC power and the power receiving antenna, the impedance adjustment circuit being capable of causing a change in input impedance thereof; and a power reception control circuit to control the impedance adjustment circuit. The power reception control circuit consecutively changes a value of the input impedance of the impedance adjustment circuit to a value selected from among a plurality of values, determines from among the plurality of values a value at which power to be supplied to the load becomes largest, and sets and maintains the input impedance at an operating impedance value that is based on the determined value.

With the above configuration, the power reception control circuit consecutively changes the value of the input impedance of the impedance adjustment circuit to a value selected from among a plurality of values, determines from among the plurality of values a value at which power to be supplied to the load becomes largest, and sets and maintains the input impedance at an operating impedance value that is based on the determined value (which hereinafter may be referred to as an “optimum value”).

As a result, when a fluctuation in the coupling state between the power transmitting antenna and the power receiving antenna or the load has occurred, or the characteristic values of circuit elements are deviated from their design values, the efficiency of power transmission can be maintained high. The power reception control circuit may perform the operation of determining an optimum value of the input impedance when beginning a power receiving operation, for example. The operation of determining an optimum value of the input impedance may be regularly performed during power reception.

Among the plurality of values, the power reception control circuit may determine a value at which the power becomes largest as the operating impedance value. Alternatively, among the plurality of values, the power reception control circuit may determine a value that is shifted from the value at which the power becomes largest as the operating impedance value. Thus, the “operating impedance value that is based on the determined value” may be identical to the determined value, or different from the value so long as similar action and effects are obtained.

In the present disclosure, an “antenna” is an element to wirelessly transmit or receive electric power through electromagnetic coupling between a pair of antennas. An antenna may encompass, e.g., a coil, or two or more electrodes.

The power receiving circuit may include a rectifier circuit. The impedance adjustment circuit may be disposed on a transmission path between the rectifier circuit and the load, for example. The power receiving circuit may include an impedance matching circuit that is connected between the power transmitting antenna and the rectifier circuit.

The power receiving device may further include a charge-discharge control circuit to control charging and discharging of an electrical storage device that is included in the load. The impedance adjustment circuit may be connected between the rectifier circuit and the charge-discharge control circuit.

The impedance adjustment circuit may include a DC-DC converter circuit. By controlling the DC-DC converter circuit, the power reception control circuit can change the input impedance. For example, the power reception control circuit may adjust the input impedance of the DC-DC converter circuit by controlling the ON time ratio of a switching element included in the DC-DC converter circuit. The ON time ratio of a switching element is controlled based on the duty ratio of a control signal that is input to the switching element. Using the DC-DC converter circuit makes it easy for the input impedance to be finely changed, or changed in multiple steps.

The power receiving device may further include a detector to detect an input power of the impedance adjustment circuit or an output power of the impedance adjustment circuit. The power reception control circuit may control the impedance adjustment circuit based on the value of the power as detected by the detector. The detector may be configured to detect the power at a position away from the impedance adjustment circuit.

The power reception control circuit may consecutively change the value of the input impedance to a value selected from among three or more values. The power reception control circuit may use the hill-climbing method to determine the value of the input impedance at which the detected power becomes largest. In this case, the power reception control circuit monitors the power in the power receiving circuit while gradually increasing or decreasing the input impedance, and determines an input impedance value at which the power becomes largest or a value in that neighborhood as the operating impedance value.

The power reception control circuit performs an operation from setting the input impedance to an initial value among the plurality of values to determining the value of the input impedance at which the power becomes largest in an amount of time shorter than 1 second, for example. In one example, this operation may be performed in an amount of time shorter than e.g. 100 milliseconds. By determining an optimum value of the input impedance in such a short time, a power receiving operation can be begun early, with the input impedance having been set to the optimum value.

A wireless power transmission system according to an embodiment of the present disclosure includes the above power receiving device and a power transmitting device. The wireless power transmission system performs wireless power transmission by an electric field coupling method or a magnetic field coupling method, for example. The “electric field coupling method” refers to a method which wirelessly transmits electric power through electric field coupling between two or more transmission electrodes and two or more reception electrodes. The “magnetic field coupling method” refers to a method which wirelessly transmits electric power through magnetic field coupling between a power transmitting coil and a power receiving coil. In a wireless power transmission system based on the electric field coupling method, a power transmitting antenna includes two or more transmission electrodes, whereas a power receiving antenna includes two or more reception electrodes. In a wireless power transmission system based on the magnetic field coupling method, a power transmitting antenna includes a power transmitting coil, whereas a power receiving antenna includes a power receiving coil. Although the present specification will mainly describe embodiments of wireless power transmission systems based on the electric field coupling method, the configuration of each embodiment of the present disclosure is similarly applicable to a wireless power transmission system based on the magnetic field coupling method.

The power transmitting device includes a power transmitting antenna and a power transmitting circuit to supply AC power to the power transmitting antenna. In one embodiment, the power transmitting circuit is capable of operating in a low power mode of supplying first AC power to the power transmitting antenna and a high power mode of supplying second AC power to the power transmitting antenna, the second AC power being higher than the first AC power. While the power transmitting circuit is operating in the low power mode, the power reception control circuit consecutively changes the value of the input impedance to a value selected from among the plurality of values, determines from among the plurality of values a value at which power to be supplied to the load becomes largest, and sets and maintains the input impedance at an operating impedance value that is based on the determined value. After the input impedance is set to the operating impedance value, the power transmitting circuit switches from the low power mode to the high power mode.

With the above configuration, the operation in which the power receiving device consecutively changes the impedance value in order to determine an optimum value of the impedance is performed with relatively low power. Thereafter, the impedance is set to the optimum value, and power transmission at higher power is begun. With such an operation, even if an impedance mismatch between circuits occurs due to change in impedance, damage to the circuit elements can be reduced. In the following description, the low power mode may be referred to as a “preliminary power transmission mode”, and the high power mode may be referred to as a “main power transmission mode”.

The power transmitting circuit may include an inverter circuit that is connected to the power transmitting antenna, a voltage adjustment circuit to adjust the voltage to be input to the inverter circuit, and a power transmission control circuit to control the inverter circuit and the voltage adjustment circuit. By controlling the voltage adjustment circuit, the power transmission control circuit is able to switch the low power mode and the high power mode.

The electric power during the preliminary power transmission may be set to less than e.g. 1/10 of the electric power during the main power transmission. In one example, the electric power during the preliminary power transmission may be set to less than 1/100 of the electric power during the main power transmission. For instance, when the rated power during the main power transmission is 1 kW, the electric power during the preliminary power transmission may be set to several W to several tens of W, for example.

The voltage adjustment circuit may include a DC-DC converter connected between the inverter circuit and an external DC power supply, or an AC-DC converter connected between the inverter circuit and an external AC power supply. The power transmission control circuit is able to adjust the voltage to be input to the inverter circuit by controlling the duty ratio of a control signal to be input to a switching element in the DC-DC converter or AC-DC converter circuit. This allows the electric power during the preliminary power transmission to be smaller than the electric power during the main power transmission.

The wireless power transmission system may include a movable unit that includes the power receiving device. The movable unit may include a power receiving device and an electric motor that is driven with electric power that is output from the power receiving circuit. The movable unit may further include an electrical storage device such as a secondary battery or a capacitor.

The movable unit is not limited to a vehicle such as the aforementioned AGV, but encompasses any movable object that is driven by electric power. Examples of movable units may include an electric vehicle that includes an electric motor and one or more wheels. Such a vehicle may be the aforementioned AGV, an electric vehicle (EV), or an electric cart, for example. The “movable unit” within the meaning of the present disclosure also encompasses any movable object that lacks wheels. For example, bipedal robots, unmanned aerial vehicles (UAV, or so-called drones) such as multicopters, and manned electric aircraft are also encompassed within “movable units”.

Hereinafter, more specific embodiments of the present disclosure will be described. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, identical or similar constituent elements are denoted by identical reference numerals.

### EMBODIMENTS

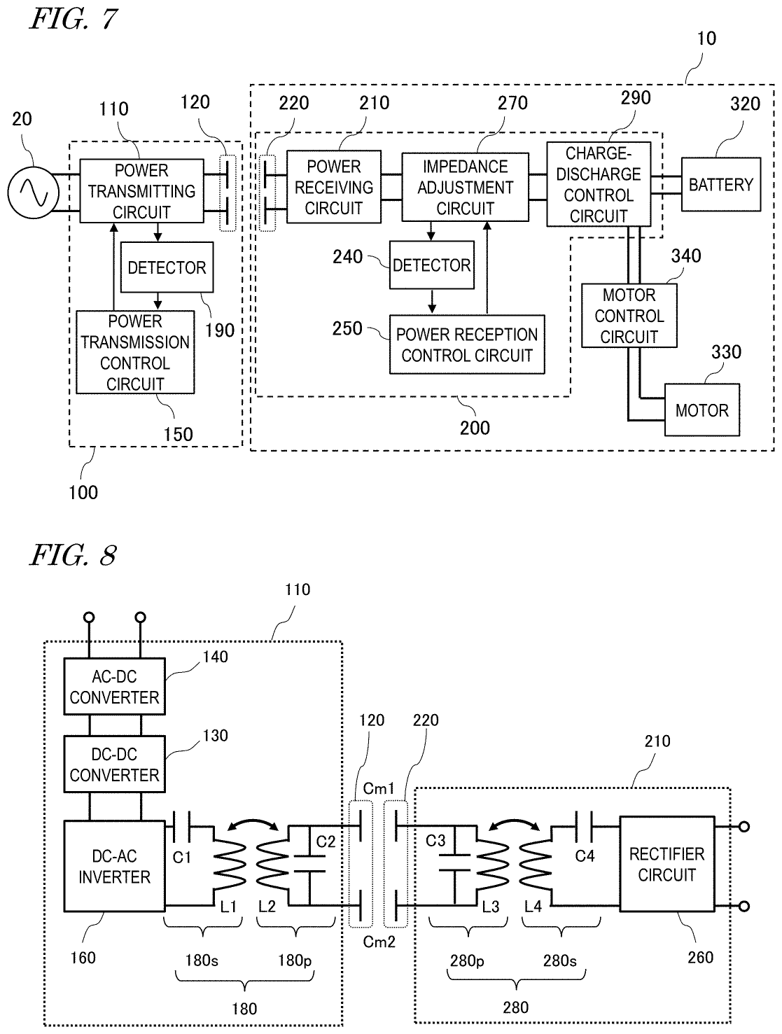

FIG. 7 is a block diagram showing the configuration of a wireless power transmission system according to an illustrative embodiment of the present disclosure. The wireless power transmission system includes a power transmitting device 100 and a movable unit 10. The movable unit 10 includes a power receiving device 200, a secondary battery 320 which is an electrical storage device, an electric motor 330 for driving purposes, and a motor control circuit 340. FIG. 7 also shows a power supply 20, which is an external element to the wireless power transmission system. Hereinafter, the secondary battery 320 may simply be referred to as the “battery 320”, and the electric motor 330 for driving purposes may simply be referred to as the “motor 330”.

The power transmitting device 100 includes two transmission electrodes 120 functioning as the power transmitting antenna, a power transmitting circuit 110 to supply AC power to the two transmission electrodes 120, a detector 190, and a power transmission control circuit 150. The detector 190 detects a voltage and a current in the power transmitting circuit 110. Based on an output from the detector 190, the power transmission control circuit 150 controls the power transmitting circuit 110.

The power receiving device 200 includes two reception electrodes 220 functioning as the power receiving antenna, a power receiving circuit 210, an impedance adjustment circuit 270, a detector 240, a power reception control circuit 250, and a charge-discharge control circuit 290. While respectively being opposed to the two transmission electrodes 120, the two reception electrodes 220 receive AC power from the transmission electrodes 120. The power receiving circuit 210 converts the AC power received by the reception electrodes 220 into DC power, and outputs it. The impedance adjustment circuit 270 is connected between the power receiving circuit 210 and the charge-discharge control circuit 290. The detector 240 detects input power to the impedance adjustment circuit 270. Based on the result of detection by the detector 240, the power reception control circuit 250 controls the input impedance of the impedance adjustment circuit 270. The charge-discharge control circuit 290 monitors the charge state of the secondary battery 320, and controls charging and discharging. The charge-discharge control circuit 290 is also referred to as a battery management unit (BMU). The charge-discharge control circuit 290 also has the function of protecting cells in the secondary battery 320 from overcharging, overdischarging, overcurrent, high temperature, low temperature, or other states.

Hereinafter, the respective component elements will be described more specifically.

The power supply 20 may be an AC power supply for commercial use, for example. The power supply 20 outputs an AC power with a voltage of 100 V and a frequency of 50 Hz or 60 Hz, for example. The power transmitting circuit 110 converts the AC power supplied from the power supply 20 into an AC power of a higher voltage and a higher frequency, and supplies it to the pair of transmission electrodes 120.

The secondary battery 320 is a rechargeable battery, such as a lithium-ion battery or a nickel-metal hydride battery. The movable unit 10 is able to move by driving the motor 330 with the electric power stored in the secondary battery 320. Instead of the secondary battery 320, a capacitor for electrical storage purposes may be used. For example, a high-capacitance and low-resistance capacitor, such as an electric double layer capacitor or a lithium-ion capacitor, may be used.

When the movable unit 10 moves, the amount of stored electricity in the secondary battery 320 becomes lower. Therefore, recharging will be required in order to continue moving. Therefore, when the charged amount becomes smaller than a predetermined threshold value during movement, the movable unit 10 moves to the power transmitting device 100 to perform charging.

The motor 330 may be any type of motor, such as a permanent magnet synchronous motor, an induction motor, a stepping motor, a reluctance motor, or a DC motor. The motor 330 rotates wheels of the movable unit 10 via a transmission mechanism, e.g., shafts and gears, thus causing the movable unit 10 to move.

The motor control circuit 340 controls the motor 330 to cause the movable unit 10 to perform a desired operation. The motor control circuit 340 may include various circuits, such as an inverter circuit, that are designed in accordance with the type of the motor 330.

Although not particularly limited, the respective sizes of the housing of the movable unit 10 according to the present embodiment, the transmission electrodes 120, and the reception electrodes 220 may be set to the following sizes, for example. The length (i.e., the size along the Y direction) of each transmission electrode 120 may be set in a range from 50 cm to 20 m, for example. The width (i.e., the size along the X direction) of each transmission electrode 120 may be set in a range from 5 cm to 2 m, for example. The sizes along the traveling direction and the lateral direction of the housing of the movable unit 10 may be set in a range from 20 cm to 5 m, for example. The length of each reception electrode 220 may be set in a range from 5 cm to 2 m, for example. The width of each reception electrode 220a may be set in a range from 2 cm to 2 m, for example. The gap between two transmission electrodes, and the gap between two reception electrodes, may be set to a range from 1 mm to 40 cm, for example. However, these numerical ranges are not limiting.

FIG. 8 is a diagram showing a more specific exemplary configuration of the power transmitting circuit 110 and the power receiving circuit 210. The power transmitting circuit 110 includes an AC-DC converter circuit 140, a DC-DC converter circuit 130, a DC-AC inverter circuit 160, and a matching circuit 180. In the following description, the AC-DC converter circuit 140 may simply be referred to as the “converter 140”. The DC-DC converter circuit 130 may be referred to as the “DC-DC converter 130”. The DC-AC inverter circuit 160 may be referred to as the “inverter 160”.

The converter 140 is connected to the AC power supply 20. The converter 140 converts the AC power which is output from the AC power supply 20 into DC power, and outputs it. The inverter 160, which is connected to the converter 140, converts the DC power which is output from the converter 140 into an AC power of a relatively high frequency, and outputs it. The DC-DC converter 130 is a circuit that adjusts the voltage to be input to the inverter 160. In response to a command from the power transmission control circuit 150, the DC-DC converter 130 alters the voltage to be input to the inverter 160. The matching circuit 180, which is connected between the inverter 160 and the transmission electrodes 120, matches the inverter 160 and the transmission electrodes 120 in impedance. The transmission electrodes 120 send the AC power which is output from the matching circuit 180 out into space.

The reception electrodes 220 establish electric field coupling with the transmission electrodes 120, and receive at least a portion of the AC power which is sent out from the transmission electrodes 120. A matching circuit 280, which is connected between the reception electrodes 220 and a rectifier circuit 260, matches the reception electrodes 220 and the rectifier circuit 260 in impedance. The rectifier circuit 260 converts the AC power which is output from the matching circuit 280 into DC power, and outputs it. The DC power which is output from the rectifier circuit 260 is sent to the impedance adjustment circuit 270.

In the example shown in the figure, the matching circuit 180 of the power transmitting device 100 includes a series resonant circuit 180s which is connected to the inverter 160, and a parallel resonant circuit 180p which is connected to the transmission electrodes 120 and establishes inductive coupling with the series resonant circuit 180s. The series resonant circuit 180s of the power transmitter 100 includes a first coil L1 and a first capacitor C1 being connected in series. The parallel resonant circuit 180p of the power transmitter 100 includes a second coil L2 and a second capacitor C2 being connected in parallel. The first coil L1 and the second coil L2 constitute a transformer whose coupling is based on a predetermined coupling coefficient. The turns ratio between the first coil L1 and the second coil L2 is set to a value that realizes a desired step-up ratio. The matching circuit 180 steps up a voltage on the order of several ten to several hundred v which is output from the inverter 160 to a voltage on the order of several kV, for example.

The matching circuit 280 of the power receiving device 200 includes a parallel resonant circuit 280p which is connected to the reception electrodes 220 and a series resonant circuit 280s which is connected to the rectifier circuit 260 and establishes inductive coupling with the parallel resonant circuit 280p. The parallel resonant circuit 280p includes a third coil L3 and a third capacitor C3 being connected in parallel. The series resonant circuit 280s of the power receiving device 200 includes a fourth coil L4 and a fourth capacitor C4 being connected in series. The third coil L3 and the fourth coil L4 constitute a transformer whose coupling is based on a predetermined coupling coefficient. The turns ratio between the third coil L3 and the fourth coil L4 is set to a value that realizes a desired step-down ratio. The matching circuit 280 steps down a voltage on the order of several kV which is received by the reception electrodes 220 to a voltage on the order of several ten to several hundred v, for example.

Each coil in the resonant circuits 180s, 180p, 280p and 280s may be a planar coil or a laminated coil formed on a circuit board, or a wound coil in which a copper wire, a litz wire, a twisted wire or the like is used, for example. For each capacitor in the resonant circuits 180s, 180p, 280p and 280s, any type of capacitor having a chip shape or a lead shape can be used, for example. A capacitance between two wiring lines with air interposed between them may be allowed to function as each capacitor. The self-resonance characteristics that each coil possesses may be utilized in the place of any such capacitor.

The resonant frequency f0 of the resonant circuits 180s, 180p, 280p and 280s is typically set to be equal to the transmission frequency f1 during power transmission. It is not necessary for the resonant frequency f0 of each of the resonant circuits 180s, 180p, 280p and 280s to be exactly equal to the transmission frequency f1. The resonant frequency f0 of each may be set to a value in the range of about 50 to about 150% of the transmission frequency f1, for example. The frequency f1 of the power transmission may be e.g. 50 Hz to 300 GHz; 20 kHz to 10 GHz in one example; 20 kHz to 20 MHz in another example; and 80 kHz to 14 MHz in still another example.

In the present embodiment, what exists between the transmission electrodes 120 and the reception electrodes 220 is an air gap, with a relatively long distance therebetween (e.g., about 10 mm). Therefore, the capacitances Cm1 and Cm2 between the electrodes are very small, and impedances of the transmission electrodes 120 and the reception electrodes 220 are very high (e.g., on the order of several kΩ). On the other hand, the impedances of the inverter 160 and the rectifier circuit 260 are as low as about several Q. In the present embodiment, the parallel resonant circuits 180p and 280p are disposed so as to be closer to, respectively, the transmission electrodes 120 and the reception electrodes 220; and the series resonant circuits 180s and 280s are disposed closer to, respectively, the inverter 160 and the rectifier circuit 260. Such configuration facilitates impedance matching. A series resonant circuit has zero (0) impedance during resonance, and therefore is suitable for matching with a low impedance. On the other hand, a parallel resonant circuit has an infinitely large impedance during resonance, and therefore is suitable for matching with a high impedance. Thus, as in the configuration shown in FIG. 8, disposing a series resonant circuit on the circuit with low impedance and disposing a parallel resonant circuit on the electrode with high impedance facilitates impedance matching.

In configurations where the distance between the transmission electrodes 120 and the reception electrodes 220 is shortened, or a dielectric is disposed therebetween, the electrode impedance will be so low that an asymmetric resonant circuit configuration is not needed. In the absence of impedance matching issues, one or both of the matching circuits 180 and 280 may be omitted. In the case of omitting the matching circuit 180, the inverter 160 and the transmission electrodes 120 are directly connected. In the case of omitting the matching circuit 280, the rectifier circuit 260 and the reception electrodes 220 are directly connected. In the present specification, a configuration where the matching circuit 180 is provided also qualifies as a configuration in which the inverter 160 and the transmission electrodes 120 are connected. Similarly, a configuration where the matching circuit 280 is provided also qualifies as a configuration in which the rectifier circuit 260 and the reception electrodes 220 are connected.

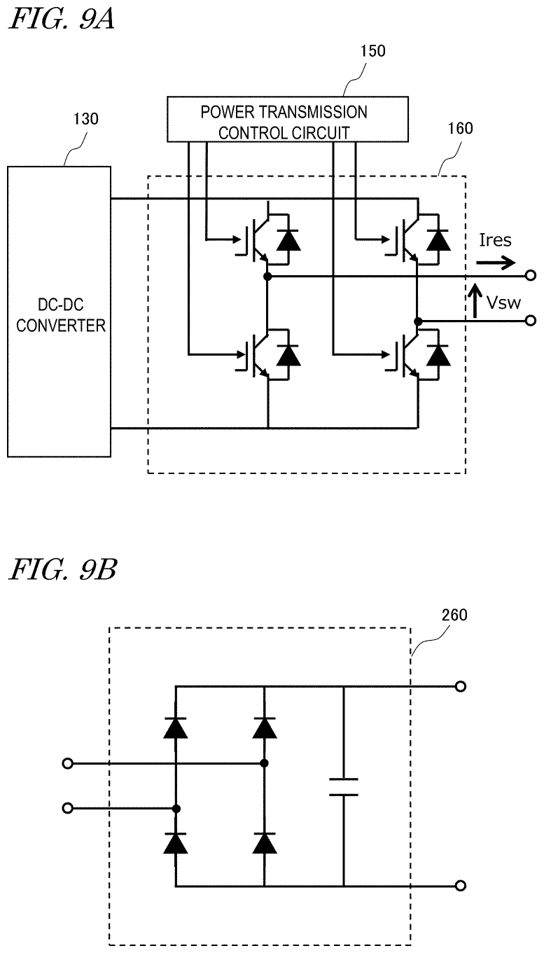

FIG. 9A is a diagram schematically showing an exemplary configuration for the inverter 160. In this example, the inverter 160 is a full-bridge inverter circuit that includes four switching elements and the power transmission control circuit 150. Each switching element may be a transistor switch such as an IGBT or a MOSFET. The power transmission control circuit 150 includes a gate driver which outputs a control signal to control the ON (conducting) or OFF (non-conducting) state of each switching element and a microcontroller unit (MCU) which causes the gate driver to output a control signal. Instead of the full-bridge inverter that is shown in the figure, a half-bridge inverter, or any other oscillation circuit, e.g., that of class E, may also be used.

As shown in FIG. 9A, the current and voltage output from the inverter 160 are designated as Ires and Vsw, respectively. The current Ires and the voltage Vsw are detected by the detector 190 shown in FIG. 7. While a power transmission operation is being performed, the detector 190 detects the current Ires and the voltage Vsw for every certain period of time, for example.

FIG. 9B is a diagram schematically showing an exemplary configuration for the rectifier circuit 260. In this example, the rectifier circuit 260 is a full-wave rectifier circuit including a diode bridge and a smoothing capacitor. The rectifier circuit 260 may have any other rectifier configuration. The rectifier circuit 260 converts the received AC energy into DC energy which is available for use by the load, such as the battery 320.

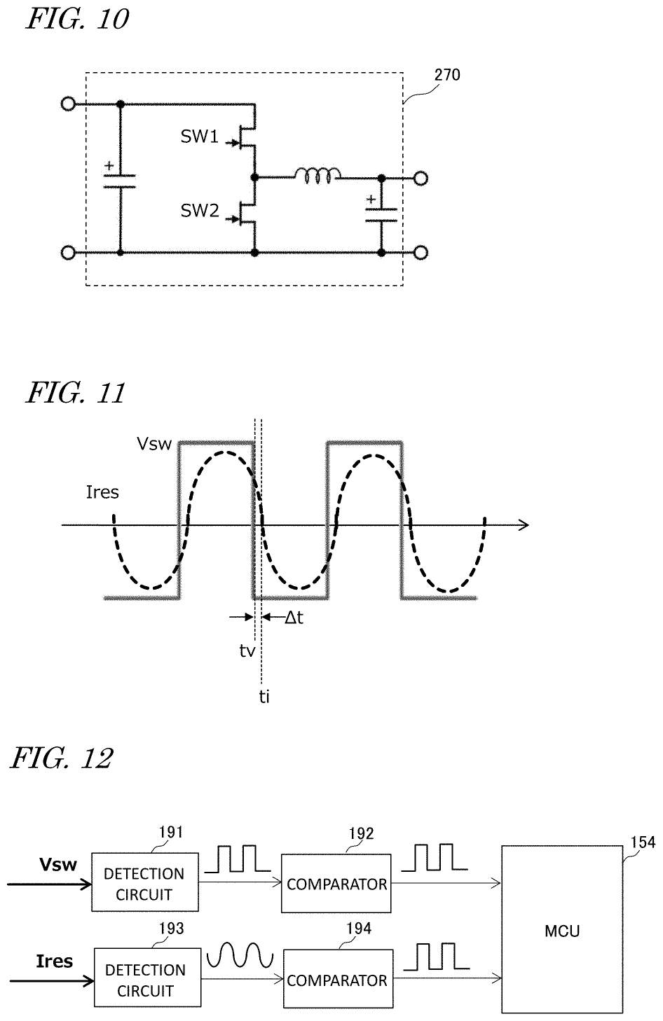

FIG. 10 is a diagram showing an exemplary configuration of the impedance adjustment circuit 270. The impedance adjustment circuit 270 in this example is a DC/DC converter. This DC/DC converter is a step-down converter (buck converter) that includes two switching elements (a HIGH-side switch SW1 and a LOW-side switch SW2), two capacitors, and a reactor. By adjusting the ON time ratio, i.e., duty ratio, of each of the HIGH-side switch SW1 and the LOW-side switch SW2, the power reception control circuit 250 is able to finely adjust the input impedance. Since it is possible to adjust the impedance within a range where the transmission state does not significantly fluctuate, influences on the circuitry associated with fluctuations in the transmission state can be suppressed. The power reception control circuit 250 may include, for example, a gate driver to output a control signal for controlling the ON/OFF state of each switching element and a microcontroller unit (MCU) to cause the gate driver to output a control signal. Note that the configuration shown in FIG. 10 is only an example; depending on the required functions or characteristics, the circuit configuration may be changed.

The detector 240 in the present embodiment detects an input power of the impedance adjustment circuit 270. The detector 240 may include a current detector and a voltage detector. The detector 240 detects a voltage and current being input to the impedance adjustment circuit 270, such that a mathematical product of these detected values is defined as the power value. Under the preliminary power transmission mode, the power reception control circuit 250 changes the input impedance of the impedance adjustment circuit 270 a plurality of times to determine a state of input impedance at which the value of the detected power becomes largest. Then, it maintains the determined state of input impedance, and continues on power reception. Once the impedance adjustments are complete, the power transmission control circuit 150 in the power transmitting device 100 switches from the preliminary power transmission mode to the main power transmission mode.

Based on changes in the output voltage Vsw and the output current Ires of the inverter 160 as detected by the detector 190, the power transmission control circuit 150 is able to detect changes in the impedance in the power receiving device 200. As a result, the power transmission control circuit 150 is able to detect completion of impedance adjustments by the power reception control circuit 250.

When the impedance adjustment circuit 270 causes a change in input impedance, the states of current and voltage within the power transmitting circuit 110 change. Based on such changes, the power transmitting device 100 is able to detect a change in input impedance. For example, when the switch SW1 shown in FIG. 10 transitions from ON to OFF and ceases its switching operation, thus taking an open state, the state of wireless power transmission changes so that the phase difference between the output voltage and the output current of the inverter 160 in the power transmitting circuit 110 changes. Specifically, a phase difference of 90° exists (where the active power equals the reactive power) in an open state. By finely adjusting the impedance by using a step-down DC/DC converter as shown in FIG. 10, the phase difference can be varied within a range of 90° or less.

FIG. 11 is a diagram showing example waveforms of the output voltage Vsw and output current Ires of the inverter 160 in the power transmitting circuit 110. As the impedance adjustment circuit 270 causes a change in impedance, as shown in FIG. 11, a difference Lt between the voltage inversion timing tv and current inversion timing ti changes. By calculating this time difference Lt (i.e., phase difference) per predetermined period, the power transmission control circuit 150 is able to detect a change in the input impedance.

FIG. 12 is a diagram showing an exemplary configuration of the detector 190 and the power transmission control circuit 150 in the power transmitting device 100. The detector 190 in the example of FIG. 11 includes: a detection circuit 191 that detects the output voltage Vsw and converts it to a voltage signal, which is a small signal; a comparator 192 for voltage phase detection purposes; a detection circuit 193 that detects the output current Ires and converts it to a voltage signal, which is a small signal; and a comparator 194 for current phase detection purposes. The power transmission control circuit 150 includes an MCU 154. With voltage divider resistors, the detection circuit 191 converts the output voltage Vsw from the inverter 160 into AC pulses of a small signal. The comparator 192 outputs them while switching between High and Low with the signal inversion timings. As a result, voltage pulses of small-amplitude are output. The comparator 194 detects the positive or negative polarity of the current waveform which is output from the detection circuit 193, and outputs this as voltage pulses of small-amplitude. These voltage pulses are input to the MCU 154. The MCU 154 detects edges of voltage pulses output from the comparator 192 and voltage pulses output from the comparator 194, thereby detecting their respective phases. Then, it calculates a phase difference between them. Note that the aforementioned detection method for phase differences is one example.

Once beginning power transmission under the preliminary power transmission mode, the power transmission control circuit 150 calculates a phase difference between the output voltage Vsw and the output current Ires of the inverter 160 per predetermined period. While the impedance adjustments in the power receiving device 200 are being made, this phase difference changes at short time intervals. When impedance adjustments are complete, the input impedance of the impedance adjustment circuit 270 is fixed at an optimum value, so that the phase difference is fixed at a certain value. Upon determining that the phase difference has remained unchanged for a certain period of time, i.e., fixed, the power transmission control circuit 150 stops the preliminary power transmission mode, and begins the main power transmission mode with higher power.

When impedance adjustments are complete, the power reception control circuit 250 may vary the input impedance of the impedance adjustment circuit 270 with a predetermined pattern and then set it to an optimum value. This allows the power transmission control circuit 150 to more accurately determine that impedance adjustments are complete.

Moreover, instead of detecting the phase difference between the output voltage Vsw and the output current Ires of the inverter 160, the power transmission control circuit 150 may measure changes in the input DC current of the inverter 160, and detect changes in the input impedance of the impedance adjustment circuit 270.

By controlling the DC-DC converter 130, the power transmission control circuit 150 is able to switch between the preliminary power transmission mode and the main power transmission mode. The DC-DC converter 130 may have a similar circuit configuration to that of the DC-DC converter in the impedance adjustment circuit 270 shown in FIG. 10. The DC-DC converter 130 serves as a voltage adjustment circuit to ensure that the electric power during the preliminary power transmission is smaller than the electric power during the main power transmission. By adjusting the ON time ratio, i.e., duty ratio, of the control signal to be input to the switching element in the DC-DC converter 130, the power transmission control circuit 150 can adjust the voltage that is output from the DC-DC converter 130. Through this, the voltage to be input to the inverter 160 is adjusted so as to be smaller during the preliminary power transmission than during the main power transmission.

Without being limited to the non-isolated DC-DC converter shown in FIG. 10, the DC-DC converter 130 may be an isolated DC-DC converter. An isolated DC-DC converter is able to cause a significant step-down with a relatively high efficiency. On the other hand, a non-isolated DC-DC converter is able to finely adjust the output voltage through duty ratio control. Depending on the use or purposes, an appropriate type of DC-DC converter may be selected. An isolated DC-DC converter and a non-isolated DC-DC converter may be together used while being connected in series. In the case where the voltage to be input to the inverter 160 significantly differs between the preliminary power transmission and the main power transmission, a DC-DC converter for the preliminary power transmission and a DC-DC converter for the main power transmission may be placed in parallel, and their operation may be switched depending on the power transmission mode. For example, in the case where such DC-DC converters are isolated DC-DC converters, the windings of the isolation transformer have different turns ratios between the DC-DC converter for the preliminary power transmission and the DC-DC converter for the main power transmission.

Instead of the DC-DC converter 130, the AC-DC converter 140 may be configured so as to be able to adjust the output DC voltage. In that case, the DC-DC converter 130 may be omitted.

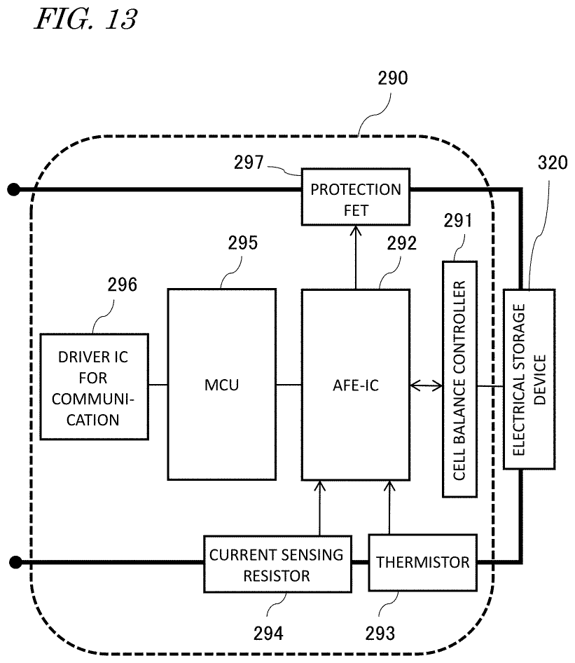

FIG. 13 is a diagram showing an exemplary configuration for the charge-discharge control circuit 290 and the impedance adjustment circuit 270. In this example, the electrical storage device 320 is a secondary battery including a plurality of cells. The charge-discharge control circuit 290 in this example includes a cell balance controller 291, an analog front-end IC (AFE-IC) 292, a thermistor 293, a current sensing resistor 294, an MCU 295, a driver IC 296 for communication purposes, and a protection FET 297. The cell balance controller 291 is a circuit which equalizes the stored electric energies in the respective cells of the secondary battery 320 that includes a plurality of cells. The AFE-IC 292 is a circuit which controls the cell balance controller 291 and the protection FET 297 based on a cell temperature measured by the thermistor 293 and a current detected by the current sensing resistor 294. The MCU 295 is a circuit which controls communications with other circuits via the driver IC 296 for communication purposes. Note that the configuration shown in FIG. 13 is only an example; depending on the required functions or characteristics, the circuit configuration may be changed.

Next, an operation of the power transmitting device 100 and the power receiving device 200 according to the present embodiment will be described.

The power transmitting device 100 has the function of detecting whether or not the movable unit 10 has arrived at a position where power can be received from the power transmitting device 100. For example, the approaching of the movable unit 10 can be detected based on a signal that is sent from a sensor or an external managing device. When the movable unit 10 has arrived at a position where power can be received, the power transmitting device 100 begins preliminary power transmission, i.e., power transmission under the low power mode.

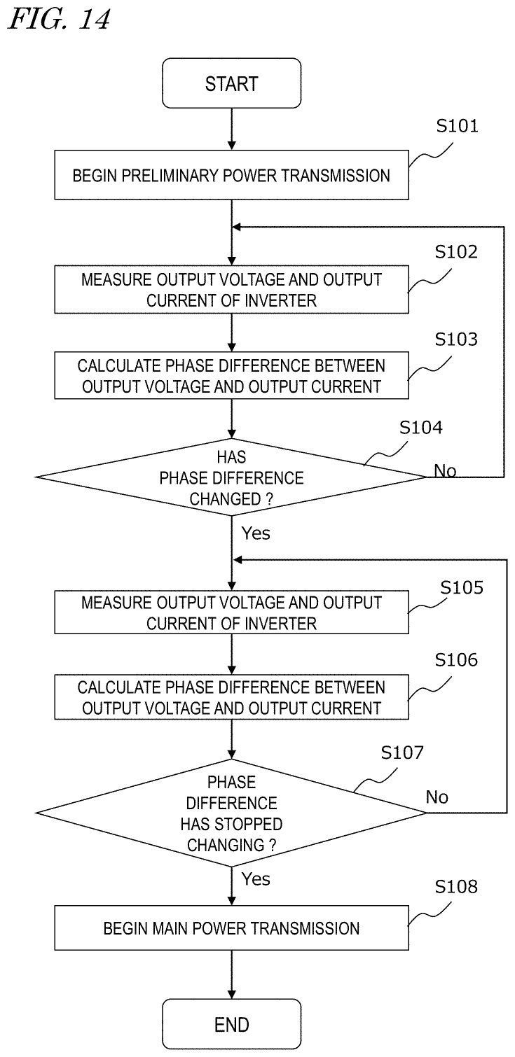

FIG. 14 is a flowchart showing an example operation by the power transmitting device 100, from the start of preliminary power transmission until the start of main power transmission. In this example, first, the power transmission control circuit 150 begins preliminary power transmission at a pre-designated frequency (step S101). Specifically, the power transmission control circuit 150 drives the DC-DC converter 130 in a preliminary power transmission mode, and drives each switching element in the inverter 160 at the initial frequency. Herein, the preliminary power transmission mode is a mode in which a lower voltage than that during the main power transmission is output from the DC-DC converter 130. For example, the power transmission control circuit 150 ensures that the duty ratio of a control signal to be input to the switching element of the DC-DC converter 130, i.e., the ON time ratio, is smaller than the duty ratio during the main power transmission, thereby lowering the voltage to be input to the inverter 160. Under the preliminary power transmission mode, a voltage as low as e.g. 1/20 to ⅓ of that under the main power transmission mode is input to the inverter 160. Thus, by performing the preliminary power transmission with low electric power, the risk of heating and damaging from circuit elements associated with an impedance mismatch during the preliminary power transmission can be reduced. However, if the risk of heating and damaging of circuit elements is small, the voltage under the preliminary power transmission mode may be made equal to the voltage under the main power transmission mode. Performing the operation under both modes with the same voltage allows the voltage switching step to be eliminated, thereby simplifying the control.

During the preliminary power transmission, the detector 190 measures the output voltage Vsw and the output current Ires of the inverter 160 (step S102). The power transmission control circuit 150 calculates a phase difference between the measured output voltage Vsw and output current Ires, and records the frequency and the phase difference in a storage medium (e.g. memory)(step S103). Next, the power transmission control circuit 150 determines whether the phase difference has changed or not (step S104). This determination may be made, for example, based on whether the magnitude of change in phase difference is larger than a predetermined threshold value or not. The operation of steps S102 to S104 is repeated until it is determined Yes at step S104.

Step S104 is performed in order to determine whether impedance adjustments have been begun at the power receiving device 200. If it is determined Yes at step S104, the detector 190 again measures the output voltage Vsw and the output current Ires of the inverter 160 (step S105). The power transmission control circuit 150 calculates a phase difference between the measured output voltage Vsw and output current Ires, and records it in a storage medium (e.g., memory)(step S106). Then, the power transmission control circuit 150 determines whether the phase difference has stopped changing or not (step S107). The power transmission control circuit 150 may determine that the phase difference has stopped changing if, for example, a state in which the phase difference remains within a predetermined small range has continued for a certain period of time or longer. The operation of steps S105 to S107 is repeated until it is determined Yes at step S107.

Step S107 is performed in order to determine whether impedance adjustments are complete and the impedance has been set to an optimum value in the power receiving device 200 or not. If it is determined at step S107 that the phase difference has stopped changing, the power transmission control circuit 150 stops preliminary power transmission under the low power mode, and begins main power transmission under the high power mode (step S108). The power transmission control circuit 150 is able to switch from preliminary power transmission to main power transmission by, for example, increasing the ON time ratio of a switching element in the DC-DC converter 130 to increase the input voltage of the inverter 160.

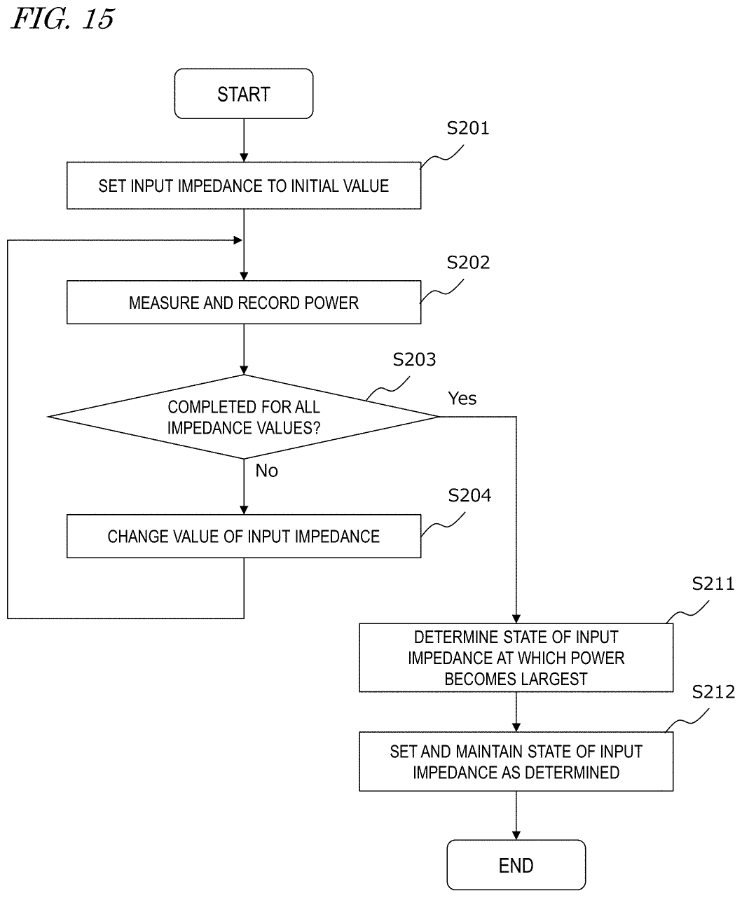

FIG. 15 is a flowchart showing an example operation of the power receiving device 200 during the preliminary power transmission. In this example, when preliminary power transmission is begun, the power reception control circuit 250 sets the input impedance of the impedance adjustment circuit 270 to an initial value that is selected from among a plurality of statuses (step S201). In other words, the power reception control circuit 250 sets a control parameter that determines the input impedance of the impedance adjustment circuit 270 to an initial value. The control parameter may be the value of a duty ratio or frequency, etc., of a control signal to be input to a switching element in the DC-DC converter that is included in the impedance adjustment circuit 270, for example. The initial value of the control parameter may be the lowest or highest value within a pre-designated range, or a central value or any other predefined value within that range, for example.

The power reception control circuit 250 measures power via the detector 240, and records this value in association with the value of the control parameter to a storage medium (step S202). The power can be determined from a mathematical product between the voltage and the current as measured by the detector 240. The power reception control circuit 250 determines whether measurement and recording of power has been finished for all of the pre-designated plurality of impedance states or not (step S203). If it is determined No, the power reception control circuit 250 changes the value of the control parameter to change the value of the input impedance (step S204). For example, if the lowest or highest value within a pre-designated range is set as the initial value of the control parameter, the value of the control parameter may be changed by adding or subtracting a small constant amount thereto or therefrom. The operation of steps S202 to S204 is repeated until it is determined Yes at step S203.

If it is determined Yes at step S203, from among the plurality of recorded values of the control parameter, the power reception control circuit 250 determines a value that defines a state of input impedance such that the power becomes largest (step S211). Then, the impedance adjustment circuit 270 is driven with the determined value or a value in that neighborhood, and the input impedance is set to and maintained at the optimum value (step S212). Thereafter, the power transmitting device 100 switches from the preliminary power transmission mode to the main power transmission mode, and power transmission is performed in an optimum impedance state.

Through the above operation, among the plurality of impedance states, it is possible to determine the impedance state that allows power transmission to be performed with the highest efficiency, and then perform main power transmission. By performing such an operation prior to beginning the main power transmission, degradation of the transmission efficiency can be suppressed even if the capacitance between the electrodes or the load state may possibly differ for each power transmission.

The values of input impedance to be set for preliminary power transmissions, i.e., values of the control parameter, may be any number which is two or greater. The greater the number of prospective values of input impedance, the higher the possibility of being able to set the input impedance to a more appropriate value will be, but the longer the time required before beginning the main power transmission will be. The number of values of input impedance to be set for preliminary power transmissions is determined depending on the permissible delay time before the main power transmission is begun. For example, in the case where the permissible delay time is 100 milliseconds, a number of values of the control parameter that allows the input impedance to be determined in a shorter time than 100 milliseconds is chosen. In the case where the permissible time is about 30 milliseconds, if the amount of time required for the power measurement for one value of the control parameter is about 10 milliseconds, then power may be calculated for only three values of the control parameter, and an optimum value may be determined among them.

The plurality of plurality of input impedance values to be switched with one another during the preliminary power transmission can be determined by various methods. For example, a reference value may be previously chosen to be a value of the control parameter at which the power to be input to the load has its peak when the value of a load connected to the power receiving circuit 210 and the capacitance between the electrodes match their respective design values; then, the reference value, one or more values lower than the reference value, and one or more values higher than the reference value may be chosen as the values of the control parameter to be set during the preliminary power transmission. The operation of determining the optimum input impedance value may be performed not only prior to beginning the main power transmission, but also during the main power transmission. In particular, in the case where the main power transmission takes a long time, there is a high possibility that the coupling state between the antennas or the load state may vary during the main power transmission, thus illustrating the advantage of introducing the operation of changing to a more suitable impedance value during the power transmission.

In the example of FIG. 15, power is measured for all of the pre-designated plurality of input impedance values, and the input impedance value at which the power becomes largest is determined as the input impedance value during the main power transmission. Without being limited to such an operation, the optimum input impedance value may be determined by other methods. For example, an impedance value or control parameter value at which the measured power becomes maximal may be searched for by the hill-climbing method, and this value may be determined as the optimum value.

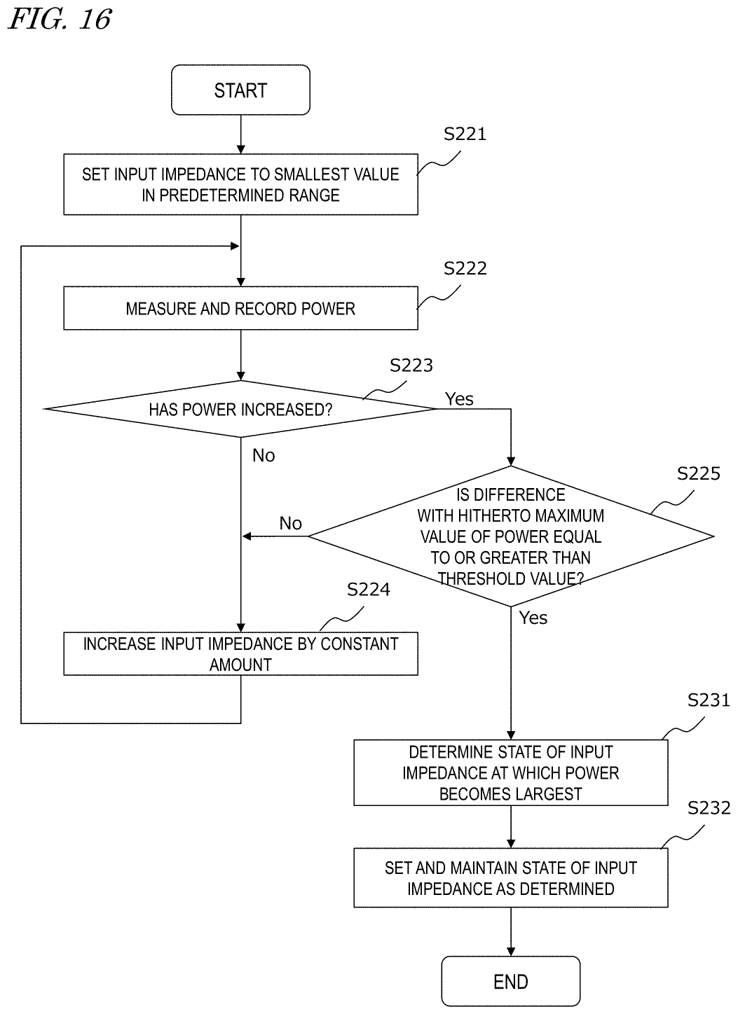

FIG. 16 is a flowchart showing an example operation where an impedance state at which power becomes maximal is determined by the hill-climbing method. In this example, first, the power reception control circuit 250 sets the input impedance of the impedance adjustment circuit 270 to the smallest within a predetermined range. Similarly to the earlier example, the power reception control circuit 250 measures the input power of the impedance adjustment circuit 270 via the detector 240, and records this value in association with the value of the control parameter (step S222). Next, the power reception control circuit 250 determines whether the power has increased from the previous power (which, at the initial time, has a sufficiently small predetermined value) or not (step S223). If it is determined Yes at step S223, the power reception control circuit 250 increases the input impedance by a constant amount by varying the value of the control parameter by a predetermined amount (step S224). The operation of steps S222 to S224 is repeated until it is determined Yes at step S223.

If it is determined Yes at step S223, the power reception control circuit 250 determines whether or not a difference between the currently-measured power and the maximum value of the hitherto measured power is equal to or greater than a threshold value (step S225). This step is performed in order to prevent a power that is actually not maximal from being erroneously determined as maximal due to noise or other causes. The threshold value is previously set to an appropriate value that is sufficiently larger than fluctuations of the signal due to noise.

If it is determined Yes at step S225, from among the plurality of recorded values of the control parameter, the power reception control circuit 250 determines a value that defines a state of input impedance at which the power becomes largest or a value in that neighborhood (step S231). Then, the impedance adjustment circuit 270 is driven with the determined value, and the input impedance is set to and maintained at the optimum value (step S232).

With the operation of FIG. 16, the preliminary power transmissions are ended as soon as identifying the state of input impedance at which the power becomes maximal; and this is then followed by the main power transmission. Therefore, it is possible to begin the main power transmission in a relatively short time.

In the example of FIG. 16, the initial value of the input impedance is set to the smallest value within a pre-designated range; however, it may be set to the largest value within the range. In that case, at step S224, the power reception control circuit 250 performs an operation of decreasing the input impedance by a constant amount. Note that, at step S224, rather than changing the input impedance by a constant amount, the amount of change may be altered in accordance with its difference with the pre-designated reference value. For example, the reference value may be chosen to be an impedance value that results in a highest efficiency when the capacitance between the electrodes and the load value are identical to their design values; the amount of change in input impedance may be monotonically decreased as it gets closer to the reference value; and the amount of change in input impedance may be monotonically increased as it gets farther away from the reference value.

The operating impedance value during the main power transmission may not be the value at which the power becomes largest among the plurality of input impedance values for which the power has been measured. So long as the action and effects in the present embodiment are obtained, any value that is different from the above-described value may be set as the operating impedance value.

The operations illustrated in FIG. 14 and FIG. 16 are only exemplary, which, in actual applications, are open to appropriate modifications. In the present embodiment, the detector 240 detects the input power of the impedance adjustment circuit 270; however, limitation to such an implementation is not intended. For example, the detector 240 may detect the output power of the impedance adjustment circuit 270, or power at any other place in the power receiving device 200. Moreover, without being limited to between the power receiving circuit 210 and the charge-discharge control circuit 290, the impedance adjustment circuit 270 may be positioned at any other place.

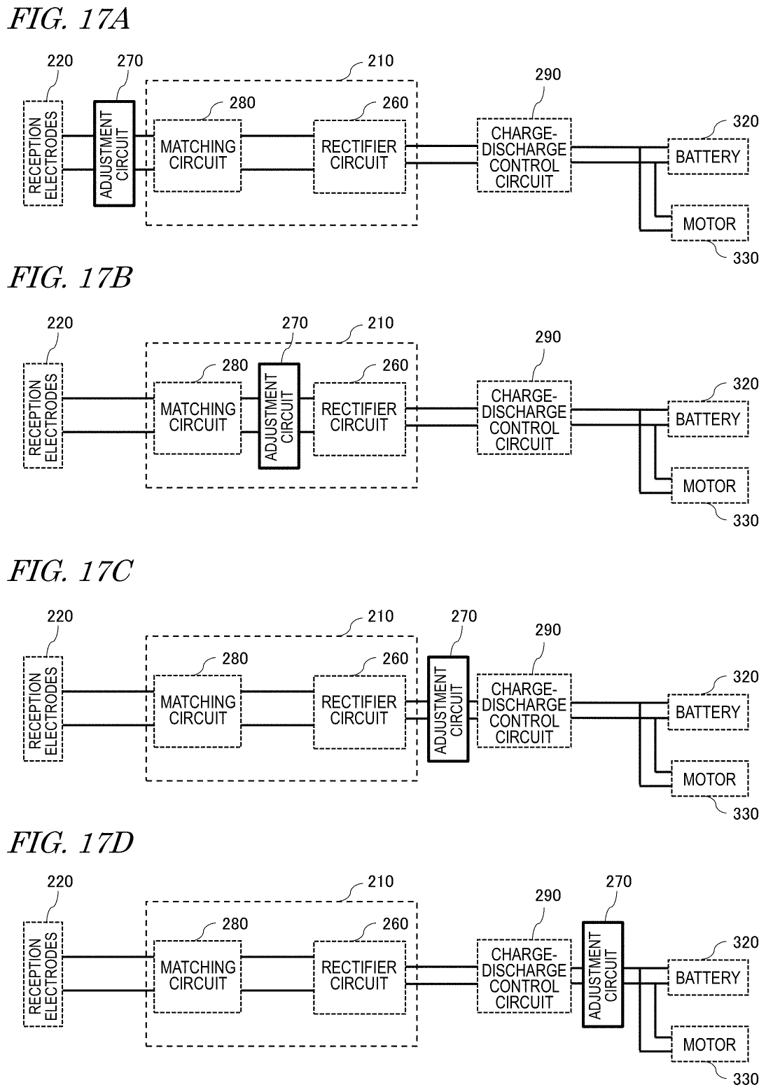

FIG. 17A to FIG. 17D are diagrams showing variations in the positioning of the impedance adjustment circuit 270. FIG. 17A shows an example where the impedance adjustment circuit 270 is positioned between the reception electrodes 220 and the power receiving circuit 210. FIG. 17B shows an example where the impedance adjustment circuit 270 is positioned between the matching circuit 280 and the rectifier circuit 260 in the power receiving circuit 210. FIG. 17C shows an example where the impedance adjustment circuit 270 is positioned between the rectifier circuit 260 in the power receiving circuit 210 and the charge-discharge control circuit 290. FIG. 17D shows an example where the impedance adjustment circuit 270 is positioned between the charge-discharge control circuit 290 and the battery 320. Thus, the impedance adjustment circuit 270 may be positioned at any arbitrary place in the transmission path between the two reception electrodes and the load. However, adopting the positioning of FIG. 17C as in the above embodiments provides the following advantages.
Since the impedance at a place where a relatively low DC voltage is applied is to be adjusted, the configuration and control of the impedance adjustment circuit 270 can be simplified.
It is possible to adjust the impedance without affecting the control of charging by the charge-discharge control circuit 290.

Although the pair of transmission electrodes 120 are installed on the ground in the above embodiments, the pair of transmission electrodes 120 may instead be installed on a lateral surface, e.g., a wall, or an overhead surface, e.g., a ceiling. Depending on the place and orientation in which the transmission electrodes 120 are installed, the arrangement and orientation of the reception electrodes 220 of the movable unit 10 are to be determined.

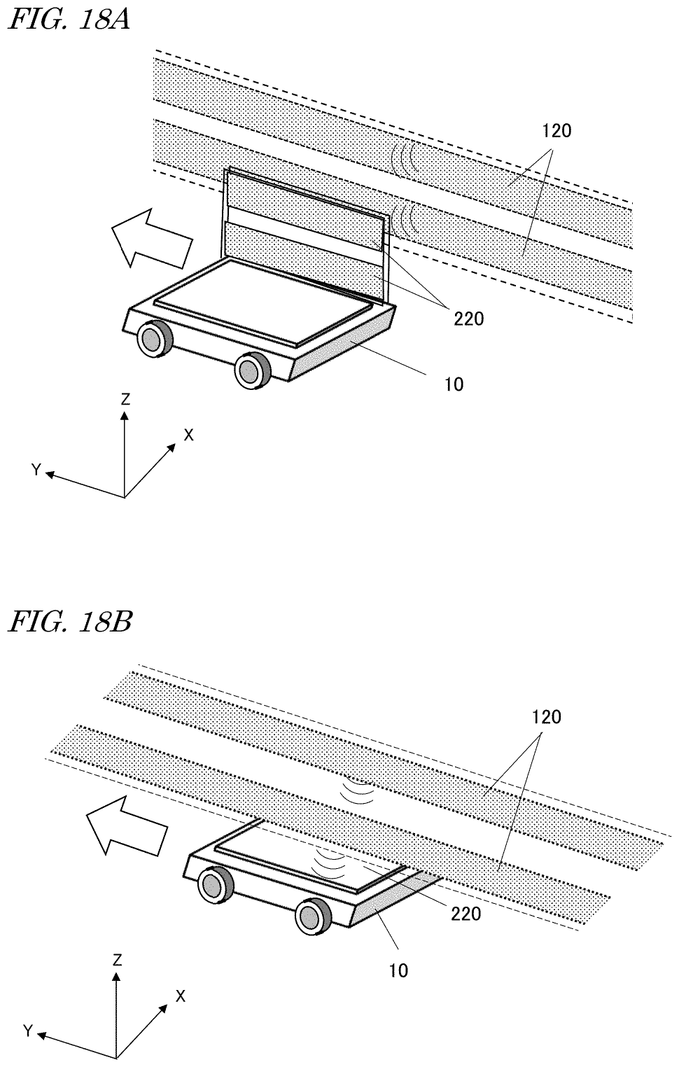

FIG. 18A shows an example where the transmission electrodes 120 are installed on a lateral surface e.g., a wall. In this example, the reception electrodes 220 are provided on a lateral side of the movable unit 10. FIG. 18B shows an example where the transmission electrodes 120 are installed on a ceiling. In this example, the reception electrodes 220 are provided on the top of the movable unit 10. As demonstrated by these examples, there may be a variety of arrangements for the transmission electrodes 120 and the reception electrodes 220.

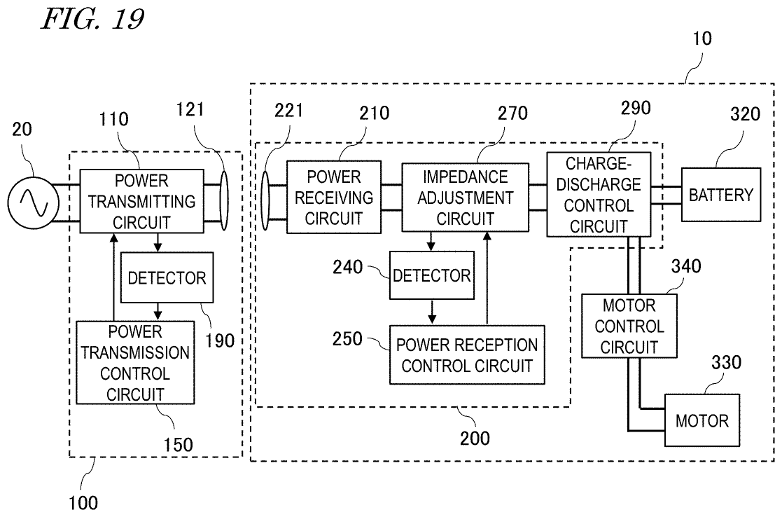

FIG. 19 is a diagram showing an exemplary configuration of a system in which electric power is wirelessly transmitted through magnetic field coupling between coils. In this example, a power transmitting coil 121 is provided instead of the transmission electrodes 120 shown in FIG. 7, and a power receiving coil 122 is provided instead of the reception electrodes 220. While the power receiving coil 122 is opposed to the power transmitting coil 121, electric power is wirelessly transmitted from the power transmitting coil 121 to the power receiving coil 221. With such a configuration, too, effects similar to those of the above embodiments can be obtained.

A wireless power transmission system according to an embodiment of the present disclosure may be used as a system of transportation for articles within a factory, as mentioned above. The movable unit 10 functions as a cart having a bed on which to carry articles, and autonomously move in the factory to transport articles to necessary places. However, without being limited to such purposes, the wireless power transmission system and the movable unit according to the present disclosure are also usable for various other purposes. For example, without being limited to an AGV, the movable unit may be any other industrial machine, a service robot, an electric vehicle, a multicopter (so-called a drone), or the like. Without being limited to being used in a factory, the wireless power transmission system may be used in shops, hospitals, households, roads, runways, or other places, for example.

### INDUSTRIAL APPLICABILITY

The technique according to the present disclosure is applicable to any device that is driven with electric power. For example, it is suitably applicable to electric vehicles, such as automated guided vehicles (AGV).

### REFERENCE SIGNS LIST

10 movable unit
20 power supply
30 floor surface
100 power transmitting device
110 power transmitting circuit
120, 120a, 120b transmission electrode
130 DC-DC converter circuit
140 AC-DC converter circuit
150 power transmission control circuit
160 DC-AC inverter circuit
180 matching circuit
180s series resonant circuit
180p parallel resonant circuit
190 detector
200 power receiving device
210 power receiving circuit
220, 220a, 220b reception electrode
240 detector
250 power reception control circuit
260 rectifier circuit
270 impedance adjustment circuit
280 matching circuit
280p parallel resonant circuit
280s series resonant circuit
290 charge-discharge control circuit
310 electrical storage device
320 secondary battery
330 electric motor
340 motor control circuit

1. A power receiving device for use in a wireless power transmission system that includes a power transmitting device and the power receiving device, the power receiving device comprising:
a power receiving antenna to wirelessly receive AC power from a power transmitting antenna in the power transmitting device;
a power receiving circuit to convert the AC power received by the power receiving antenna into DC power and to output the DC power;
an impedance adjustment circuit disposed on a transmission path between a load that utilizes the DC power and the power receiving antenna, the impedance adjustment circuit being capable of causing a change in input impedance thereof; and
a power reception control circuit to control the impedance adjustment circuit, the power reception control circuit consecutively changing a value of the input impedance of the impedance adjustment circuit to a value selected from among a plurality of values, determining from among the plurality of values a value at which power to be supplied to the load becomes largest, and setting and maintaining the input impedance at an operating impedance value that is based on the determined value.

2. The power receiving device of claim 1, wherein,
the power receiving circuit includes a rectifier circuit; and
the impedance adjustment circuit is disposed on a transmission path between the rectifier circuit and the load.

3. The power receiving device of claim 2, further comprising a charge-discharge control circuit to control charging and discharging of an electrical storage device that is included in the load, wherein
the impedance adjustment circuit is connected between the rectifier circuit and the charge-discharge control circuit.

4. The power receiving device of claim 2, wherein,
the impedance adjustment circuit includes a DC-DC converter circuit; and
the power reception control circuit changes the input impedance by controlling the DC-DC converter circuit.

5. The power receiving device of claim 1, further comprising a detector to detect an input power of the impedance adjustment circuit or an output power of the impedance adjustment circuit, wherein
the power reception control circuit controls the impedance adjustment circuit based on the value of the power as detected by the detector.

6. The power receiving device of claim 1, wherein the power reception control circuit consecutively changes the value of the input impedance to a value selected from among three or more values.

7. The power receiving device of claim 1, wherein the power reception control circuit uses the hill-climbing method to determine the value of the input impedance at which the power to be supplied to the load becomes largest.

8. The power receiving device of claim 1, wherein, in an amount of time shorter than 1 second, the power reception control circuit performs an operation from setting the input impedance to an initial value among the plurality of values to determining the value of the input impedance at which the power becomes largest.

9. The power receiving device of claim 1, wherein,
the power transmitting antenna includes two or more transmission electrodes; and
the power receiving antenna includes two or more transmission electrodes for electric field coupling with the two or more transmission electrodes.

10. A movable unit comprising:
the power receiving device of claim 1; and
an electric motor to be driven by power that is output from the power receiving circuit.

11. A wireless power transmission system comprising:
the power receiving device of claim 1; and
the power transmitting device.

12. The wireless power transmission system of claim 11, wherein,
the power transmitting device includes
a power transmitting antenna, and
a power transmitting circuit to supply AC power to the power transmitting antenna;
the power transmitting circuit is capable of operating in a low power mode of supplying first AC power to the power transmitting antenna and a high power mode of supplying second AC power to the power transmitting antenna, the second AC power being higher than the first AC power;
while the power transmitting circuit is operating in the low power mode, the power reception control circuit consecutively changes the value of the input impedance to a value selected from among the plurality of values, determines from among the plurality of values a value at which power to be supplied to the load becomes largest, and sets and maintains the input impedance at an operating impedance value that is based on the determined value; and
after the input impedance is set to the operating impedance value, the power transmitting circuit switches from the low power mode to the high power mode.
